(19) United States
(12) Patent Application Publication
(10) Pub. No.: US 2021/0053531 A1
(43) Pub. Date: Feb. 25, 2021

(54) VEHICLE WITH A DEVICE FOR PASSIVE ACCESS CONTROL

(71) Applicant: Hella GmbH & Co. KGaA, Lippstadt (DE)

(72) Inventor: Muhammad Fawad Panhwar, Paderborn (DE)

(21) Appl. No.: 16/977,674

(22) PCT Filed: Mar. 7, 2019
(86) PCT No.: PCT/EP2019/055675

§ 371 Date: Sep. 2, 2020

(30) Foreign Application Priority Data
Mar. 14, 2018 (DE) 10 2018 105 837.3

(51) Int. Cl. B60R 25/24; G06K 7/10; B60R 25/20; H01Q 1/32; H01Q 1/42; H01Q 19/10

(52) U.S. Cl. CPC B60R 25/245; G06K 7/10316; B60R 25/209; G06Q 2240/00; H01Q 1/3283; H01Q 1/42; H01Q 19/10; H01Q 1/3241

(57) ABSTRACT

A vehicle with a device for passive authorization control is provided. The device features ultra-wideband antenna devices, by means of which the device with an electronic key for checking authorization for access is able to communicate activation of a function or the starting of the vehicle. At least one of the antenna devices features at least one reflector that is arranged at a distance from one ultra-wideband antenna of the antenna device.

### CROSS REFERENCE

This application claims priority to PCT Application No. PCT/EP2019/055675, filed Mar. 7, 2019, which itself claims priority to German Application No. 10 2018 105837.3, filed Mar. 14, 2018, the entirety of both of which are hereby incorporated by reference.

### FIELD OF THE INVENTION

The invention relates to a vehicle with a device for passive authorization control, where the device features ultra-wideband antenna devices, by means of which the device with an electronic key for checking authorization for access is able to communicate activation of a function or the starting of the vehicle.

### BACKGROUND

A vehicle is known from document EP 2 800 068 A2 with a device for passive authorization control featuring more than one ultra-wideband antenna devices. The device for passive authorization can communicate, via the antenna device, with an electronic key for checking authorizations. The document EP 2 800 068 A2 mainly concerns mechanisms for the prevention of what are known as relay attacks that can be used for the theft of vehicles with passive entry/passive go systems.

The use of ultra-wideband signals for passive authorization control is still not very widespread and was consequently examined by the applicant. It transpired the the previous device concepts for passive authorization control for use with ultra-wideband signals need to be refined to achieve good results.

It emerged, for example, that there may be problems with coverage of the immediate vicinity of the vehicle with signals from the ultra-wideband antenna device. This means that areas in the immediate vicinity of the vehicle are not covered uniformly. This may lead to a situation where the signals of the ultra-wideband antenna devices do not reach an electronic key in the vicinity and passive authorization cannot be performed.

### SUMMARY OF THE INVENTION

In accordance with the invention, this problem is solved by least one of the antenna devices featuring at least one reflector that is arranged at a distance from an ultra-wideband antenna of the antenna device. The arrangement of a reflector in the antenna device makes it better than previously possible to ensure that signals from the antenna are directed into the desired directions. Instead of previously uncontrolled reflections on parts of the body or other parts of the vehicle, reflections now occur, with a vehicle in accordance with the invention, that can be set or at least influenced by means of the reflector in such a way that in the area of the antenna device largely uniform and seamless coverage by the signals transmitted by the antenna device can be achieved.

The reflector may be a reflector plate or comprise a reflector plate. It is possible for the reflector to be part of the body of the vehicle or form part of the body of the vehicle. The body then features a special area that is designed as a reflector to bring about the desired behavior of the antenna device.

An antenna device of a vehicle in accordance with the invention may feature a housing. The reflector may be formed within the housing by a housing wall and on a housing wall. The reflector may, for example, be a galvanic coating of a housing wall.

In principle, the reflector may be of any shape. In particular, it may be flat or convex.

It has proven to be especially beneficial for the antenna and the reflector allocated to it to feature a distance of approx. 5 mm to 30 mm, specifically approx. 15 mm to 30 mm, for example 10 mm.

A vehicle in accordance with the vehicle may have more than one antenna device. It is possible for the antenna device or each of the antenna devices to have more than one antenna.

The antenna or the antennas of an antenna device may be suitable and set up for transmitting linearly polarized UWB signals.

An electronic key for a vehicle in accordance with the invention or another suitable vehicle may feature an antenna for linearly polarized UWB signals. This has the advantage over an antenna for circularly polarized signals that the antenna may be smaller and require less area and/or installation space. The antenna of such a key may be stamped part. Simple adaptations of the stamped part make it possible to set the antennas to a preferred frequency range. One section of the stamped part may be a triangular or rounded monopole. A large bandwidth can be achieved in particular by means of a rounded monopole. Using a stamped part instead of an antenna formed by tracks on a circuit carrier makes it possible to reduce the amount of spaced needed for the antenna. There are benefits even in comparison to a ceramic SMD antennas, namely the greater robustness of the stamped part in comparison to a ceramic antenna.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a schematic diagram of an antenna arrangement in a vehicle.

### DETAILED DESCRIPTION OF THE DRAWINGS

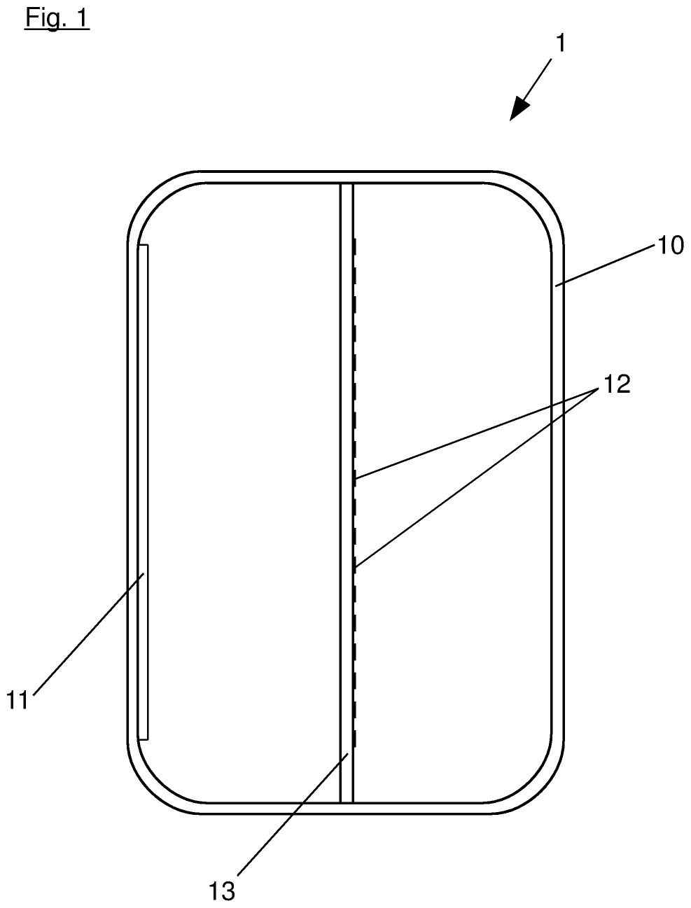

The antenna arrangement 1 shown in FIG. 1 features a housing 10 made of plastic in which the antenna is arranged. The antenna 12 is formed by tracks on a circuit carrier 13. The antenna arrangement 1 further features a reflector 11 that is designed to have a distance of approx. 10 mm to the antenna. The reflector 11 is designed to be on a housing wall and implemented in the form of a coating of the housing wall.

The housing 10 and thus the entire antenna arrangement 1 are mounted at an azimuth angle individual to each vehicle in relation to a direction longitudinal to the vehicle, preferentially in the area of a bumper or a vehicle lamp, behind a plastic cover on the bumper or the vehicle lamp that are penetrated by the signals transmitted by the antenna arrangement 1 and to be received by the antenna arrangement 1. The azimuth angle may, for example, be between 10 and 30° in relation to the direction longitudinal to the vehicle.

### LIST OF REFERENCE SYMBOLS

1 Antenna arrangement
10 Housing
11 Reflector
12 Antenna
13 Circuit carrier

1. A device for passive authorization control of a vehicle, the device including:
an electronic key for checking authorization for access;
ultra-wideband antenna devices by means of which the device communicates activation of a function or the starting of the vehicle,
wherein at least one of the antenna devices features at least one reflector that is arranged at a distance from an ultra-wideband antenna of the antenna device.

2. The vehicle in accordance with claim 1, wherein the reflector includes a reflector plate.

3. The vehicle in accordance with claim 1, wherein the reflector forms a part of the body of the vehicle.

4. The vehicle in accordance with claim 1, wherein the antenna device features a housing and the reflector is positioned within the housing and is formed by a housing wall and on a housing wall.

5. The vehicle in accordance with claim 4, wherein the reflector is a coating of a housing wall.

6. The vehicle in accordance with claim 1, wherein the reflector is flat.

7. The vehicle in accordance with claim 1, wherein the reflector is convex.

8. The vehicle in accordance with claim 1, wherein the antennas and the reflector allocated to them feature a distance of approx. 10 mm.

9. The vehicle in accordance with claim 1, wherein the antenna device features more than one antenna.

10. The vehicle in accordance with claim 1, wherein the antenna device is suitable and set up for transmitting linearly polarized signals.
